(19) United States
(12) Patent Application Publication
(10) Pub. No.: US 2007/0184160 A1
(43) Pub. Date: Aug. 9, 2007

(54) Vegetable dough, a process for its production and vegetable bakery products made therewith

(76) Inventors: Leyla Josef, Haifa (IL); Shirley Ofir, Atzmon (IL); Michael Shemer, Haifa (IL)

Correspondence Address: Kevin D McCarthy;Roach Brown McCarthy and Gruber, 1620 Liberty Building, Buffalo, NY, 14202, US

(21) Appl. No.: 10/589,169

(22) PCT Filed:
(86) PCT No.: PCT/IL05/00193

(30) Foreign Application Priority Data
Feb. 16, 2004 (IL) 160430

(51) Int. Cl. A21D 6/00

(52) U.S. Cl. 426/496

(57) ABSTRACT

Vegetable-based dough that comprises softened gluten and added vegetable material. The vegetables comprise legumes and/or fruits and/or fibers. The Vegetable dough essentially consists of softened gluten in admixture with vegetable materials or of an essentially homogeneous mixture of softened gluten, to which vegetable material has been added. The vegetable dough is produced by first softening a gluten mass, and then by mixing the resulting softened gluten with a preferred vegetable, until an essentially homogeneous mass is obtained.

### FIELD OF THE INVENTION

The present invention relates to the field of foodstuff. More particularly, the present invention relates to a vegetable-based dough.

### BACKGROUND OF THE INVENTION

Increasing attention is now given to improving properties of foodstuff, such as taste, aroma, coloration, nutrient quality, long shelf-life and aesthetic appearance. Thanks to its binding properties, wheat dough is traditionally used as a basic ingredient, or plays a major role, in many kinds of baked food stuffs. Wheat dough can be used alone, such as when it is desired to bake bread, cookies, crackers, wafers, biscuits, cakes, etc., or be used as a base for, e.g., pies, pizzas, puff pastry or filo bakery, etc. Wheat dough can also be used as a wrapper, for wrapping, e.g., rolls, burritos, burekas, empanadas, etc. Therefore, one trivial way to improve, or to change, properties of food stuffs containing wheat dough, is to change the characteristics/properties of the traditional dough.

In general, vegetables are known to contain health-beneficial ingredients, such as various vitamins, minerals, fibers and other minor ingredients which contribute to our well being, such as antioxidants, phytosterols, carotenes, etc., and, therefore, there is a growing awareness to their importance. However, the taste of vegetables is generally not liked by many people, and therefore, people do not like eating them. Therefore, several ways have been developed to enjoy the benefits of vegetables despite of their sensory shortcomings. For example, methods have been developed to extract vitamins/minerals from vegetables and to consume them as food additives. Other ways focus on changing the taste and structure of vegetables, such as by processing them with other edible materials.

Another important evolving field is directed towards meat analog products. That is, vegetable-based foodstuffs are currently produced and consumed as a substitute for meat and fish.

It would be advantageous to find an industrially efficient way to make dough that is enriched with vegetable material. Vegetable-enriched dough will be beneficial for people so they will consume more vegetables, because of their health beneficial ingredients. The vegetable-enriched dough would allow people to consume e.g., pizzas, burekas, etc. which they could not previously, or did not want to, consume for health reasons.

Gluten is the main ingredient in the wheat flour, and its characteristics affect, among other things, the workability of the dough and the final appearance of the food product. For example, the characteristics of bread made from wheat flour are directly attributable to the presence of gluten. The process of bread making involves changing and improving the natural properties of gluten. Traditionally, this occurs during the kneading and fermentation of the dough over several hours (i.e., up to 12 hours). Modern bread making processes rely on other means of modifying the gluten, which processes allow to make good quality bread in about two hours.

Currently, gluten is utilized as a basic material in various protein foods of vegetable derivation to achieve a texture which simulates that of meat and meat products in general. There are several references that describe various methods for processing gluten and manufacturing diversified products thereof. For example, U.S. Pat. No. 3,290,152 discloses a protein uniform synthetic food product that is obtained from a finely divided dehydrated wheat gluten and water, by a simultaneous rapid cutting of the mixture at high speed to keep the water and wheat gluten particles in intimate mixture.

U.S. Pat. No. 4,238,515 discloses a new physical form of gluten, including a method for its manufacturing and uses thereof. The new type of gluten is obtained by agitating wheat gluten with a reducing agent at a temperature below 70° C., and incorporating, during the agitation, a solid inert material, for example, a textured vegetable protein. The preferred reducing agents suggested are sodium sulfite and sodium bisulfite.

US 2003/00916698 discloses the utilization of reduced gluten for obtaining a protein-based dough-like material, that is processable much like high-carbohydrate dough (i.e., a conventional wheat-based dough). According to US 2003/00916698, the final fabricated food contains a very high level of protein and a very low level of carbohydrate, but yet it mimics a high-carbohydrate food product, such as chips, crackers, wafers, cookies, biscuits, cakes, etc.

DE 3700953 discloses the preparation of soft pastry that has excellent features regarding slicing firmness, mean density, porosity type, uniformity, elastic texture, and a much reduced calorific value. According to DE 3700953, the pastry is made using a mixture of components, one component of which is fruit and/or vegetable material. The preferred percentage of the fruit and/or vegetable material is stated to be around 45%, and the fruit/vegetable can be either fresh, cooked, frozen, or otherwise preserved. However, the exemplary recipes, which are disclosed in this reference, refer only to different kinds of breads, and the relatively low content of vegetables/fruits contained therein may be attributable to the fact that the dough used for making these breads contains high percentage of flour dough, which imparts to the resulting dough poor to moderate binding properties.

Therefore, it is an object of the invention to provide a dough-like material that is enriched with (i.e., contains higher content of) vegetable material, as compared to traditionally processed dough, or dough-like materials.

It is another object of the invention to provide a dough-like material that contains vegetable material as a main ingredient.

The terms “vegetables” or “vegetable material”, as used herein, are meant to indicate every kind of vegetable material and their derivatives, including but not limited to legumes, fruits, and fibers. Accordingly, the terms “vegetable”, “vegetable-based dough” and the like will be used herein in all cases, having the aforesaid broad meaning, for the sake of brevity.

Furthermore, the term vegetable is meant to comprise fresh, canned, preserved, refrigerated, frozen, pickles, dehydrated, partially rehydrated, vegetables as well as vegetable juices, concentrates, purees and pastes. Similarly, the term fruit is meant to comprise fresh, canned, preserved, refrigerated, frozen, pickles, dehydrated, partially rehydrated fruits as well as fruit juices, concentrates, purees and pastes.

It is another object of the invention to provide a vegetable-based dough, which, despite being based primarily on vegetable material as a main ingredient, has physical characteristics, such as elongation, break elongation, tensile strength, volume expansion, adhesion, die cutting characteristics, fibrous structure and molded form retention, that are very similar to those of a flour dough.

It is still another object of the invention to provide vegetable based dough that is processable in a manner similar to flour dough.

It is still another object of the invention to provide a vegetable based dough that works within numerous existing food process systems, such as direct reduction sheeting, lamination sheeting, die cutting, enrolling and molding processes followed by baking, drying, boiling, steaming, frying, seasoning, enrobing, and/or a combination thereof.

Other objects and advantages of the invention will become apparent as the description proceeds

### SUMMARY OF THE INVENTION

The present invention provides an edible, vegetable-based dough-like material and a process for its preparation.

According to the invention, the edible, vegetable-based dough-like material comprises reduced gluten, in admixture with high proportions (as exemplified hereinafter) 20-80%, preferably 40-60% of vegetable ingredients, as hereinbefore defined.

The vegetable-based dough according to the invention comprises: a) softened gluten; and b) added vegetable material.

The term “softened”, as used herein, is also meant to comprise the terms “reduced”, “relaxed”, “conditioned” and “gluey”, which are commonly used in the art to indicate gluten which has undergone a modification in its elastic properties, as further discussed hereinafter.

According to a preferred embodiment of the invention the vegetables comprise legumes and/or fruits and/or fibers.

In one aspect, the invention therefore relates to vegetable dough consisting essentially of softened gluten in admixture with vegetable materials.

In another aspect the invention relates to vegetable dough consisting of an essentially homogeneous mixture of softened gluten to which vegetable material has been added

The vegetable dough of the invention can contain a large amount of vegetable ingredients (as hereinbefore defined), typically about 20-80%.

According to a preferred embodiment of the invention the vegetable dough comprises about 40-60% of vegetable ingredients.

The vegetable dough of the invention possesses elastic properties, which are essential to the invention. The elastic properties of the dough will be discussed in greater detail hereinafter.

The vegetable dough of the invention is preferably (but not limitatively) prepared using wheat gluten.

According to a preferred embodiment of the invention the vegetable dough may further comprise additional ingredients selected from the group consisting of food additives, flavorings, spices, herbs, seeds, seasonings, natural colors, vitamins, minerals, starch, starch products, sugars, carbohydrates, yeasts, fibers, flavor enhancers, grains, cereals, cereal products, mushrooms, salt, nuts, baking goods, egg, dairy products, vegetable or other proteins, fats, oils and water.

The invention is also directed to vegetable-based bakery products made by baking the dough of the invention. In a preferred embodiment of the invention additional edible materials are added to the dough prior to baking, which may comprise, e.g., cut or diced vegetables.

In another aspect the invention is directed to a process for producing vegetable dough, comprising:
Softening a gluten mass, and
Mixing the resulting softened gluten with a preferred vegetable until an essentially homogeneous mass is obtained.

In a preferred embodiment of the invention the gluten mass is softened by reducing it using a reducing agent. It should be appreciated that the process of the invention is a two-stage process. In the first stage the gluten is softened, to provide an elastic dough basis, and in the second step vegetable material is added to the softened gluten, while maintaining said elastic properties. This two-stage process is an essential feature of the invention.

Gluten softening agents and the usage thereof for softening (e.g., reducing) gluten are well known in the art. For example, U.S. Pat. No. 4,938,976, of the inventor thereof, describes the reduction of gluten by agitating the gluten with ascorbic acid in the presence of a solution of an edible acid at a pH in a preferred range of between 5.0 and 7.0, and at a temperature below 70° C., to produce a reduced gluten in the form of a viscous liquid-like structure. Other commonly used reducing agents are, e.g., various sulfite agents (sodium or potassium salts of sulfite, bisulfite and metabisulfite), tocopherol, butylated hydroxyanisole and butylated hydroxytoluene and cysteine.

Other softening agents are found in nature. Thus for instance, the invention also encompasses the use of vegetable material as natural gluten softening agent, together with, or instead of, chemical gluten reducing agents. One of the examples described hereinafter illustrates the use crushed tomatoes for this purpose.

Additional ingredients may be added to the dough made according to the invention, e.g., ingredients selected from the group consisting of food additives, flavorings, spices, herbs, seeds, seasonings, natural colors, vitamins, minerals, starch, starch products, sugars, carbohydrates, yeasts, fibers, flavor enhancers, grains, cereals, cereal products, mushrooms, salt, nuts, baking goods, egg, dairy products, vegetable or other proteins fats, oils and water.

### DETAILED DESCRIPTION OF PREFERRED EMBODIMENTS

Three tests were conducted in order to demonstrate that dough consisting of reduced gluten has, relative to flour dough and to dough consisting of non-reduced gluten, an improved texture that enhances its self-binding property even when mixed with high content of vegetable material. By ‘improved texture’ is meant, among other things, improved extensibility, cohesion, viscosity and break strength. However, only the extensibility and break strength were measured quantitatively in the aforesaid three tests, as being indicative criteria for the binding capability of dough.

Accordingly, the extensibility and break strength properties were measured with respect to three kinds of dough: (1) dough consisting of reduced gluten and a vegetable; (2) dough consisting of ‘ordinary’ (non-reduced) gluten and a vegetable, and (3) standard dough consisting of wheat flour. Several samples were tested for each kind of dough.

The ingredients of each one of the three kinds of dough are given in Table 1, whereas the measurement results, relating to each type of dough, are summarized in Table 2.

### Vegetable Dough Extensibility Test—Test Conditions

The test was conducted using a Texture Analyzer of Stable Micro Systems Ltd. The extensibility of dough was tested with the attachment: Kiefer dough & gluten extensibility Rig (A/KIE), which is a micro-extension solution for accurate determination of dough and gluten extensibility

The attachment included a preparation press & mould, spring loaded test rig and hook. The sample of the dough was shaped by the mould and pressed into dough stripes. The dough was left in the mould to relax before the stripes were removed from the mould. The dough stripes were gently placed on the sample plate. The sample plate was inserted into the rig for carrying out the testing of the sample, as follows: The hook of the testing gear was raised to extend the dough sample until its elastic limit was exceeded and the dough separated. The results are given in the form of maximal force (resistance to extension) and distance to break (extensibility). The extensibility properties enables the processing and shaping of the dough into traditional baked products such as puff pastry, bread, etc.

### Test Settings of the Testing Equipment

Mode: measure force in tension

Pre-test speed: 2.0 mm/s

Test speed: 3.3 mm/s

Post test speed: 10.0 mm/s

Distance: 75 mm

Trigger force: Auto-5 g

Data acquisition: 200 points per second (pps)

Dough Formulation:

TABLE 1

| | | Dough type B: | |
|---|---|---|---|
| | Dough type A: | Vegetable dough | |
| | Vegetable dough | (without | Dough type C: |
| Ingredients: | (with previously | previous reduced | Standard wheat |
| (in %) | reduced gluten) | gluten) | flour dough |
| Wheat Gluten | 8 | 8 | |
| Vinegar and | 1 | | |
| Vitamin C | | | |
| Water | 15 | 15 | 31 |
| Salt | 0.8 | 0.8 | 1 |
| Wheat flour | 8 | 8 | 62 |
| Pea fiber | 5 | 5 | |
| Potato flakes | 3 | 3 | |
| Corn meal | 3 | 3 | |
| Crushed Frozen | 49.4 | 50.4 | |
| vegetables | | | |
| Sugar | 3 | 3 | |
| Methyl cellulose | 0.8 | 0.8 | |
| Spices and | 3 | 3 | |
| flavorings | | | |
| Margarine | | | 6 |
| Total | 100 | 100 | 100 |

Dough Preparation:
1) With respect to Dough type A: The following ingredients were added to a high speed mixer—gluten, water, vinegar and vitamin C, after which they were mixed thoroughly until a reduced-gluten was obtained, which had a viscous sticky consistency. Then, the other ingredients (shown in Table 1) were added to the agitator and mixed together with the reduced gluten, until smooth dough was obtained.
2) With respect to Dough types B and C: All of the ingredients were mixed for 30 seconds in the high-speed mixer.
   Preparation of Dough Samples:

16 grams of each type of dough were taken and pressed into the mould, leaving the dough to relax therein for 30 minutes. Then, the strips of dough were removed from the mould and tested.

Test Results:

TABLE 2

| | Dough type A: | Dough type B: | |
|---|---|---|---|
| | Vegetable | Vegetable | Dough type C: |
| | dough | dough(non- | Standard Wheat |
| | (reduced gluten) | reduced gluten) | flour dough |
| Number of | 8 | 8 | 8 |
| repetition | | | |
| Maximum | 0.41 | 0.08 | 0.25 |
| Force (N) | | | |
| (Average) | | | |
| Distance at | 16.1 | 0.03 | 40.9 |
| Max force | | | |
| (mm) (Average) | | | |

With respect to dough type B, due to the relatively poor texture of a non-reduced gluten, the samples of dough type B did not stretch and tear and the relatively low value of the ‘Maximal force’ (0.08, in table-2) is due primarily to the effect of the pulling hook (i.e., of the testing gear) cutting its way through the dough strip (instead of stretching, or extending the dough sample).

From the results shown in Table 2 it can be seen that, for Dough type C (wheat flour dough), a maximal force of 0.25 N was exerted, which resulted in a maximal stretch distance of 40.9 mm, whereas in the case of Dough type A (dough with reduced gluten), a higher maximal force was exerted (0.41 N), but, yet, the maximal stretch distance was significantly shorter (only 16.1 mm). The comparative results shown in Table 2 thus demonstrate that the binding properties of the vegetable dough that was made using reduced gluten (dough type A) were significantly improved comparing to the binding properties of the dough in which the gluten was not reduced (dough type B).

Some exemplary food products were made using vegetable dough, in order to demonstrate the improved binding properties of the vegetable dough. All of the food products showed a texture that is consistent with the improved characteristics/properties of the vegetable dough, as described hereinabove.

### EXAMPLE 1

### Recipe and Preparation of “Tomato Puff Pastry Dough”

### For the Preparation of 300 gr. of Tomato Puff Pastry Dough

To prepare 300 g of tomato puff pastry dough: crush in a food processor 36 g frozen tomatoes, 36 g frozen zucchini, 29 g frozen sweet potatoes, 3.6 g frozen onion, 5.9 g tomato puree and 0.7 g frozen garlic.

In a high speed mixer add 19.3 g gluten, 36.2 g water, 0.9 g vinegar, 0.1 g vitamin c, and mix thoroughly until the gluten has a viscous sticky consistency. Afterwards add the crushed vegetables, 28 g wheat flour, 12.7 pea fibers, 7.2 g dried potato flakes, 7.2 g corn meal, 4.8 g egg albumen, 1.9 g methyl cellulose, 1.9 g salt, 8.4 g sugar, 3.2 g spices, flavorings and natural colorings. Mix well till you get 243 g of smooth dough.

The dough is laminated with 47 g margarine, and 10 g of wheat flour to prevent sticking. After the laminating process you get a tomato puff pastry dough that could be used in various products. Baking time of the final product varies according to the application.

### EXAMPLE 2

### Recipe and Preparation of “Tomato Bread”

To prepare 500 g of tomato bread: crush in a food processor 83 g frozen tomatoes, 88 g frozen zucchini, 66 g frozen sweet potatoes, 8.3 g frozen onion, 21 g tomato puree, 2 g frozen garlic.

In a high speed mixer add 25 g gluten, 47 g water, 1.1 g vinegar, 0.1 g vitamin c, and mix thoroughly until the gluten has a viscous sticky consistency. Afterwards add the crushed vegetables, 40 g wheat flour, 10.5 pea fibers, 14.6 g dried potato flakes, 16.7 g corn meal, 12.5 g egg albumen, 4.2 g methyl cellulose, 21 g of vegetable oil, 4.2 g salt, 22 g sugar, 6.3 g spices, flavorings and natural colorings. Mix thoroughly and add 6.5 g baking yeast. Mix again. When the dough becomes smooth, let it rise for 30 minutes at 30-35° C. Form the dough and let it rise for 60 minutes at 30-35° C. Bake the dough at 180° C. for 60 minutes.

### EXAMPLE 3

### Recipe and Preparation of “Spinach Puff Pastry Dough”

To prepare 300 g of spinach puff pastry dough: crush in a food processor 83 g frozen spinach, 22 g frozen onion, 18 g fried onion and 1.8 g frozen basil.

In a high-speed mixer add 17.6 g gluten, 32.8 g water, 0.8 g vinegar, 0.1 g vitamin c, and mix thoroughly until the gluten has a viscous sticky consistency. Afterwards add the crushed vegetables, 14 g wheat flour, 12 g pea fibers, 6.6 g dried potato flakes, 4.4 g corn meal, 6.6 g egg albumen, 2.2 g methyl cellulose, 2.2 g salt, 1 g sugar, 11 g vegetable oil, 1.9 g spices, flavorings and natural colorings. Mix well till you get 238 g of smooth dough.

The dough is laminated with 47 g margarine, and 15 g of wheat flour to prevent sticking. After the laminating process you get a spinach puff pastry dough that could be used in various products. Baking time of the final product varies according to the application.

### EXAMPLE 4

### Recipe and Preparation of “Cauliflower Puff Pastry Dough”

To prepare 300 g of cauliflower puff pastry dough: crush in a food processor 77 g frozen cauliflower, 33 g frozen cabbage and 17 g frozen onion.

In a high-speed mixer add 17.6 g gluten, 32.8 g water, 0.8 g vinegar, 0.1 g vitamin c, and mix thoroughly until the gluten has a viscous sticky consistency. Afterwards add the crushed vegetables, 14 g wheat flour, 12 g pea fibers, 8.8 g dried potato flakes, 6.6 g egg albumen, 2.2 g methyl cellulose, 2.2 g salt, 11 g vegetable oil, 2.9 g spices, flavorings and natural colorings. Mix well till you get 238 g of smooth dough.

The dough is laminated with 47 g margarine, and 15 g of wheat flour to prevent sticking. After the laminating process you get a cauliflower puff pastry dough that could be used in various products. Baking time of the final product varies according to the application.

### EXAMPLE 5

### Recipe and Preparation of “Chickpeas Puff Pastry Dough”

To prepare 300 g of chickpeas puff pastry dough: crush in a food processor 166.7 g canned chickpeas.

In a high-speed mixer add 18.7 g gluten, 34.8 g water, 0.8 g vinegar, 0.1 g vitamin c, and mix thoroughly until the gluten has a viscous sticky consistency. Afterwards add the crushed chickpeas, and 10.7 g dried potato flakes, and 2.2 g salt. Mix well till you get 234 g of smooth dough.

The dough is laminated with 47 g margarine, and 19 g of wheat flour to prevent sticking. After the laminating process you get the chickpeas puff pastry dough could be used in various products. Baking time of the final product varies according to the application.

### EXAMPLE 6

### Recipe and Preparation of “Fiber Rich Puff Pastry Dough”

To prepare 300 g of fiber rich puff pastry dough: add 127.8 g of water to a mixture of 7.1 g pea fiber and 7.1 g of wheat fiber. Mix well and let it stand for 10 minutes.

In a high-speed mixer add 17.7 g gluten, 33 g water, 0.8 g vinegar, 0.1 g vitamin c, and mix thoroughly until the gluten has a viscous sticky consistency. Afterwards add the soaked fibers, 13.2 g corn meal, 15 g dried potato flakes, and 2.2 g salt. Mix well till you get 224 g of smooth dough.

The dough is laminated with 45 g margarine, and 31 g of wheat flour to prevent sticking. After the laminating process you get a fibers puff pastry dough could be used in various products.

### EXAMPLE 7

### Recipe and Preparation of “Rich Tomato Puff Pastry Dough”

To prepare 300 g of rich tomato puff pastry dough: crush in a food processor 41 g frozen zucchini, 29 g frozen sweet potatoes, 3.6 g frozen onion, 7.2 g tomato puree, 0.7 g frozen garlic and 60 g frozen tomatoes.

In a high speed mixer add 19.1 g gluten, 37 g of the crushed tomatoes, and mix thoroughly until the gluten has a viscous sticky consistency. Afterwards add the rest of the crushed vegetables, 20 g wheat flour, 13.3 pea fibers, 9.6 g dried potato flakes, 9.4 g corn meal, 4.8 g egg albumen, 1.9 g methyl cellulose, 1.9 g salt, 8.2 g sugar, 9.6 g vegetable oil, 2.7 g spices, flavorings and natural colorings. Mix well till you get 242 g of smooth dough.

The dough is laminated with 48 g margarine, and 10 g of wheat flour to prevent sticking. After the laminating process you get a tomato puff pastry dough that could be used in various products. Baking time of the final product varies according to the application.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. Vegetable-based dough, comprising: a) softened gluten; and b) added vegetable material.

2. Vegetable dough according to claim 1, wherein the vegetables comprise legumes and/or fruits and/or fibers.

3. Vegetable dough according to claim 1, consisting essentially of softened gluten in admixture with vegetable materials.

4. Vegetable dough according to claim 1, consisting of an essentially homogeneous mixture of softened gluten to which vegetable material has been added.

5. Vegetable dough according to claim 1, comprising 20-80% of vegetable ingredients, as hereinbefore defined.

6. Vegetable dough according to claim 5, comprising 40-60% of vegetable ingredients, as hereinbefore defined.

7. Vegetable dough according to claim 1, which possesses elastic properties.

8. Vegetable dough according to claim 1, in which the gluten is wheat gluten.

9. Vegetable dough according to claim 1, wherein the dough further comprises additional ingredients selected from the group consisting of food additives, flavorings, spices, herbs, seeds, seasonings, natural colors, vitamins, minerals, starch, starch products, sugars, carbohydrates, yeasts, fibers, flavor enhancers, grains, cereals, cereal products, mushrooms, salt, nuts, baking goods, egg, dairy products, vegetable or other proteins, fats, oils and water.

10. A vegetable-based bakery product made by baking a dough comprising: a) softened gluten; and b) added vegetable material.

11. A product according to claim 10, wherein additional edible materials have been added to the dough prior to baking.

12. A product according to claim 11, wherein said additional edible materials comprise cut or diced vegetables.

13. Process for producing vegetable dough, comprising:
a) Softening a gluten mass, and
b) mixing the resulting softened gluten with a preferred vegetable until an essentially homogeneous mass is obtained.

14. Process according to claim 13, wherein the gluten mass is softened by reducing it using a reducing agent.

15. Process according to claim 13, wherein the gluten is softened by using naturally occurring softening agents found in the vegetables.

16. Process according to claim 13, wherein the gluten is wheat gluten.

17. Process according to claim 13, wherein the dough further comprises additional ingredients selected from the group consisting of food additives, flavorings, spices, herbs, seeds, seasonings, natural colors, vitamins, minerals, starch, starch products, sugars, carbohydrates, yeasts, fibers, flavor enhancers, grains, cereals, cereal products, mushrooms, salt, nuts, baking goods, egg, dairy products, vegetable or other proteins, fats, oils and water.

18. (canceled)

19. (canceled)
